(19) United States
(12) Patent Application Publication
(10) Pub. No.: US 2007/0026790 A1
(43) Pub. Date: Feb. 1, 2007

(54) Portable digital terrestrial television device comprising a device for receiving a low power digital signal

(75) Inventors: Henri Crohas, Verrieres-Le Buisson (FR); Yves Gregoire, Chatemay-Mazabkly (FR)

Correspondence Address: BROWDY AND NEIMARK, P.L.L.C.;624 NINTH STREET, NW, SUITE 300, WASHINGTON, DC, 20001-5303, US

(73) Assignee: ARCHOS, IGNY (FR)

(21) Appl. No.: 11/493,924

(22) Filed: Jul. 27, 2006

(30) Foreign Application Priority Data
Jul. 27, 2005 (FR) 0508035
Feb. 17, 2006 (FR) 0601427

(51) Int. Cl. H04H 1/00

(52) U.S. Cl. 455/3.01

(57) ABSTRACT

A portable digital terrestrial television device comprises a portable digital terrestrial television apparatus and means for receiving a low power digital signal. The reception means (30, 31) comprise two antennae for receiving the digital signal, the relative disposition of the antennae being adapted to reduce the coupling between said antennae, said antennae being borne by a support (9, 10, 81) comprising means for connecting the antennae to the portable digital terrestrial television apparatus.

### FIELD OF THE INVENTION

The present invention relates to a portable digital terrestrial television device comprising a device for receiving a low power digital signal and to a set of antennae.

### BACKGROUND OF THE INVENTION

Digital terrestrial television (DTT) reception apparatuses are implemented in accordance with the DVB-T (Digital Video Broadcasting—Terrestrial) standard.

The transmission power of the DTT signal has been set at a low level such that analog television transmissions are not perturbed.

This power level is sufficient for digital terrestrial television reception according to the DVB-T standard by means of a yagi antenna positioned on the roof, i.e. at a height of approximately ten meters above the ground.

An adaptation of the DVB-T standard has been made for the reception of digital terrestrial television on mobile and portable receivers. Thus DVB-H (“Digital Video Broadcasting for Handheld”) is a variant of DVB-T digital terrestrial television which takes into account the constraints of portable receivers.

Although producing a portable receiver exploiting a DVB-H signal is easy, the device for receiving a DVB-T signal is much more delicate to perfect.

The reception of digital television must therefore be carried out by means of an antenna situated not at around ten meters above the ground but at a considerably lower height (approximately 1.5 meters above the ground).

However, the transmission power of the DTT signal is insufficient for reception by means of such an antenna, in particular for use within constructions or in the case of reception while mobile.

Antennae with two elements are known for receiving the digital signal of digital television inside a vehicle as described by Funke and presented at the address www.funke.nl. The antennae, in particular the antennae ADSC 410-45T, are adapted to receive digital terrestrial television according to the DVB-T standard, in a mobile environment.

This antenna is composed of two elements, of which one element is longer than the second. This antenna is directional and is thus optimized for the reception of digital signals coming from a certain direction. These antennae are fixed to the vehicle and are connected to the terminal device by means of a co-axial cable.

Although this antenna is well adapted to the reception of digital terrestrial television according to the DVB-T standard, it is not appropriate for portable digital terrestrial television apparatuses that conform to that same DVB-T standard.

Thus, the following problems occur on implementation of a portable digital terrestrial television reception apparatus integrating reception antennae, for example:
mechanical constraints: more particularly, as the digital terrestrial television apparatus is portable, the reception means must be adapted in order to be also portable and mobile with the digital terrestrial television apparatus;
electromagnetic constraints: the digital terrestrial television apparatus in course of operation emits electromagnetic radiation which must not perturb the reception of the digital signal by the antennae;
ergonomic constraints, and
constraints related to the characteristics specific to the transmission of the DVB-T and DVB-H signals in terms of modulations, frequencies and power of the digital signal.

The object of the invention is to remedy the aforementioned problems.

### SUMMARY OF THE INVENTION

The present invention provides a portable digital terrestrial television device comprising a portable digital terrestrial television apparatus and means for receiving a digital signal of low power, characterized in that the reception means comprise two antennae for receiving the digital signal, the relative disposition of said antennae being adapted to reduce the coupling between said antennae, said antennae being borne by a support comprising means for connecting the antennae to the portable digital terrestrial television apparatus.

Given the above features, the portable digital terrestrial television device according to the invention comprises reception means formed by two antennae. These antennae have a disposition such that the antennae are decoupled so as to reduce the influence of one antenna on the other. Thus the efficiency of the device in use is optimized, by better sensitivity to a received signal level, which signal is weak in DVB-T.

A support bears these antennae which are connected to the portable digital terrestrial television apparatus.

According to one embodiment, these antennae may be antennae with spatially anisotropic sensitivity, and in particular each comprise two elements of unequal height.

According to another embodiment, these antennae are isotropic, they being for example quarter wave antennae.

It should be noted that isotropic antennae are liable to have anisotropic behavior when they are close to each other.

According to a preferred feature, the antennae borne by the support are adapted to be placed away from the portable digital terrestrial television apparatus.

According to this feature, the antennae are positioned in an antennae support which may be separated from the television device and be positioned in a configuration enabling better reception of the signal.

According to another advantageous feature, the antennae are connected to the portable digital terrestrial television apparatus by at least one wire connection.

According to another advantageous feature, the support comprises means for storing the wire connection.

According to another advantageous feature, the support comprises means for amplifying the signals captured by the antennae.

According to this feature, the signals captured by the antennae are amplified in order to ensure better transport thereof as far as the receiver contained in the television device.

According to another advantageous feature, two detachable tuners are respectively associated with said antennae and the support comprises temporary fixing means for said detachable tuners.

According to another advantageous feature, the support comprises detachable fixing means for the means for processing the diversity of the digital signals adapted to process the digital signals received.

According to another advantageous feature, the antennae comprise fixing means adapted to be fixed to a substantially vertical wall.

According to another advantageous feature, the fixing means are suckers or adhesive.

According to another advantageous feature, the portable digital terrestrial television apparatus comprises a viewing screen and the support is a protecting flap for said viewing screen.

According to another advantageous feature, the protecting flap is fixed to the portable digital terrestrial television apparatus by hinges.

According to another advantageous feature, the protecting flap, in closed position, is above the viewing screen of said portable digital terrestrial television apparatus.

According to another advantageous feature, the protecting flap, in deployed position, is adapted to serve as a prop for said portable digital terrestrial television apparatus.

According to another advantageous feature, when the protecting flap is in deployed position, the protecting flap forms an angle between 260° and 280° with said the viewing screen of the portable digital terrestrial television apparatus.

According to another advantageous feature, the protecting flap is adapted to be detached from said portable digital terrestrial television apparatus.

According to another advantageous feature, a carrying case is associated with said portable digital terrestrial television device, a flap of the carrying case forming said support and incorporating the antennae, and the flap being moveable between a closed position and a deployed position with respect to the portable digital terrestrial television apparatus.

According to another advantageous feature, when the flap is in deployed position, the flap is adapted to serve as a prop for said portable digital terrestrial television apparatus.

According to a preferred embodiment, the antennae support is constituted by an antennae case.

According to another advantageous feature, the antennae support comprises two parts hinged with respect to each other, each part comprising an antenna, the antennae support being adapted to be positioned partially or fully open with respect to the hinge axis to place the antennae away from each other.

According to another advantageous feature, the antennae case can be opened on three sides.

According to an advantageous feature, reception means comprise two tuners respectively associated with said antennae, and the portable digital terrestrial television device comprises means for processing the diversity of the digital signals adapted to process the digital signals output from said tuners.

According to these features, the transmission errors are corrected and the noise is filtered. Furthermore, the echoes due to the multiple paths followed by the received signal are treated and the Doppler effect is compensated for.

According to another advantageous feature, the portable digital terrestrial television device comprises storage means and recording means adapted to record the digital signal in the storage means.

In this way, the digital signals received may be recorded for later viewing.

According to a preferred feature, in said disposition, the two antennae are disposed at a distance from each other greater than or equal to a quarter of the wavelength of the signal to be received.

According to another aspect, the invention provides for individually covering the set of antennae borne by an aforementioned support.

Thus an object of the present invention is also to provide a set of antennae adapted to be connected to a portable digital terrestrial television apparatus, those antennae being borne by a support such that those antennae may assume a disposition adapted to reduce the coupling between them, said support further comprising means for connecting to said portable digital terrestrial television apparatus.

Thus, the antennae in a support are adapted to assume a disposition such that the antennae are decoupled from each other so as to reduce the influence of one antenna on the other.

Other aspects and advantages of the invention will appear from reading the following detailed description of particular embodiments, given by way of non-limiting example. The description refers to the accompanying drawings.

### BRIEF DESCRIPTION OF THE DRAWINGS

FIG. 1a is a view from above illustrating a portable digital terrestrial television apparatus according to a first embodiment;

FIG. 1b diagrammatically illustrates the portable digital terrestrial television apparatus;

FIG. 1c is a view from the side illustrating the portable digital terrestrial television apparatus according to the first embodiment;

FIG. 2 illustrates the position on the portable digital terrestrial television apparatus of the antennae with two elements of different size;

FIG. 3a is a view from below illustrating the orientation of the antennae according to the first embodiment;

FIG. 3b is a view from the side illustrating the orientation of the antennae according to the first embodiment;

FIG. 3c illustrates a positioning variant of the antennae viewed from the front;

FIG. 4 illustrates a second positioning variant of the antennae viewed from the front;

FIG. 5a is a view from above illustrating a portable digital terrestrial television apparatus comprising a flap integrating the antennae according to a second embodiment;

FIG. 5b is a view from the side illustrating a portable digital terrestrial television apparatus comprising a closed flap integrating the antennae according to the second embodiment;

FIG. 5c is a view from the side illustrating a portable digital terrestrial television apparatus comprising the open flap integrating the antennae according to the second embodiment;

FIG. 6 is a view from the side illustrating a portable digital terrestrial television apparatus incorporated into a case according to a third embodiment;

FIG. 7 illustrates a portable digital terrestrial television apparatus of which the antennae are placed at a distance;

FIG. 8 illustrates a variant of the device of FIG. 7 in which the antennae that are placed at a distance are borne by the same support;

FIG. 9 shows the antennae support in partially open position;

FIG. 10 shows the antennae support in fully open position;

FIG. 11 illustrates means for storage in an antennae case; and

FIG. 12 represents a portable digital terrestrial television apparatus connected to the antennae that are positioned in the antennae case.

### DETAILED DESCRIPTION

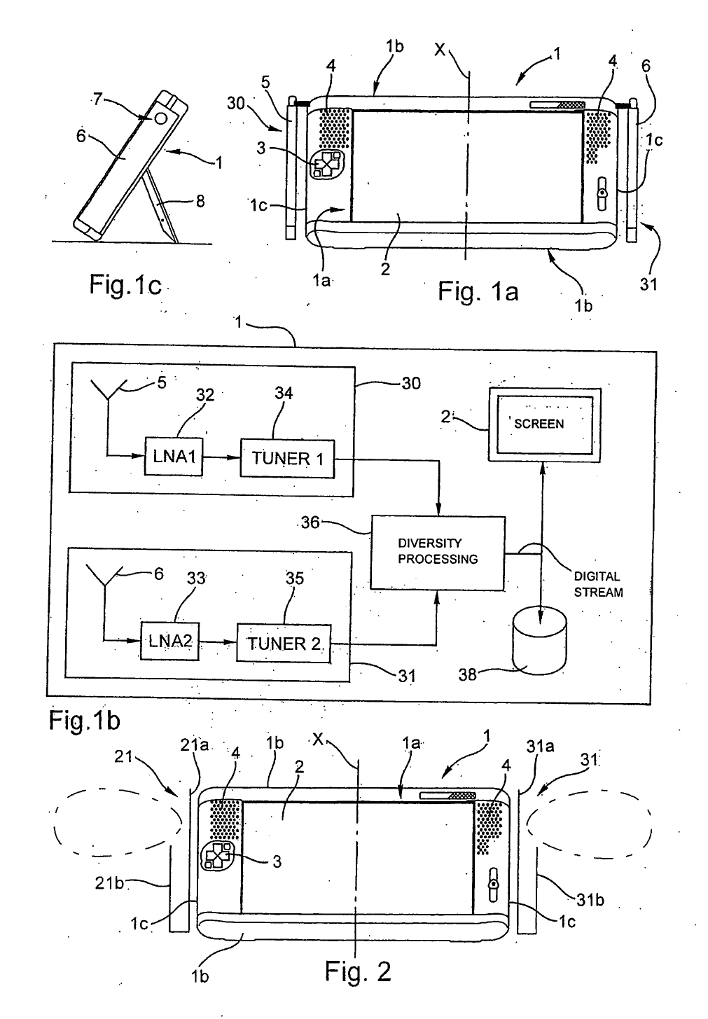

FIGS. 1a to 4 illustrate examples of particular schematic forms of portable digital terrestrial television device in which the features of the invention are included.

With reference to FIG. 1a, a particular embodiment of a portable digital terrestrial television apparatus 1 is illustrated.

The apparatus 1 comprises, on a front face 1a, a screen 2 for viewing multimedia data, in particular digital terrestrial television, control means 3, for example buttons, and audio outputs 4. The portable digital terrestrial television apparatus 1 comprises a substantially rectangular body and it comprises two longitudinal edges 1b and two lateral edges 1c.

Means for receiving television data in particular digital terrestrial television data, are connected to the apparatus, via adapted antennae, such that the apparatus can be used both in a fixed environment, in particular inside a house, as well as in a mobile environment, for example inside a car.

The portable digital terrestrial television apparatus bears two antennae 5 and 6, having a non-isotropic or anisotropic spatial sensitivity, that is to say that the reception sensitivity of an antenna is dependent upon its spatial orientation. These antennae are for example UHF or VHF antennae.

In fact, an antenna is said to be spatially anisotropic if it is optimized for reception in a favored direction. The term “directional antenna” is also used.

These antennae are of small size and operate in particular in diversity although they are situated close to the terminal and at a short distance from each other.

A mechanism implementing diversity is described in the document “A revolution for indoor DVB-T portable reception and outdoor DVB-T mobile reception” at the Internet address HYPERLINK “http://www.dibcom.net/us/document/DiBcom_Diversity_White_Paper web.pdf”

http://www.dibcom.net/us/document/DiBcom_Diversity White_Paper_web.pdf.

More particularly, the propagation of electromagnetic waves between a transmitter and a receiver follows multiple paths due to the presence of various obstacles (construction, vegetation, etc.) on which the signal reflects and refracts.

Furthermore, if the receiver moves, what is known as the “Doppler effect” occurs.

A mechanism implementing diversity performs appropriate processing such that, on the basis of two signals received on the two antennae, the mechanism produces a signal of better quality in terms of signal level and signal-to-noise ratio.

This implementation makes it possible to correct transmission errors and to filter noise, treat echoes due to the multiple paths followed by the signal received and to compensate for the Doppler effect in the case of reception in a moving vehicle.

As illustrated in FIG. 1b, the portable digital terrestrial television apparatus comprises two reception means 30 and 31, each composed of an antenna 5, 6, a LNA (Low Noise Amplifier) 32 and 33 and a tuner (also known as a “syntoniseur” in French terminology) 34 and 35.

An application of the mechanism 36 implementing diversity relies on the signals generated by the reception means 30 and 31.

This mechanism 36 performs the diversity processing by digitally and instantaneously analyzing the two signals output from the two tuners 34 and 35.

To do this, operations of comparison and combination of the two signals are carried out to get rid of ambient interference, noise induced by the propagation of the signal from its point of transmission, long and short echoes due to the reflections on the obstacles encountered, as well as the Doppler effect inherent in mobile reception.

These processing operations make it possible to generate a signal having a better C/N signal-to-noise ratio than either of the two signals taken independently.

In this way, an improvement in the reception quality and the effective region of coverage is obtained.

The digital signal output from the mechanism 36 implementing diversity may, for example, be viewed on the viewing screen 2 of the portable digital terrestrial television apparatus, or be stored in a storage means 38 by recording means.

As illustrated in FIG. 1a, the antennae are, for example, disposed symmetrically with respect to an axis of symmetry X of the portable digital terrestrial television apparatus. However, other dispositions of the antennae with respect to the apparatus may be envisaged.

According to a first embodiment, the antennae 5 and 6 are respectively in the proximity of the two opposite sides of the portable digital terrestrial television apparatus, and in particular disposed adjacent the lateral edges 1c of the portable digital terrestrial television apparatus. This disposition makes it possible to place the antenna as far as possible away with respect to electromagnetic radiation emitting parts of the apparatus.

This disposition on the portable digital terrestrial television apparatus makes it possible to place one antenna as far as possible away from the other, so as to attain if possible a distance greater than or equal to a quarter wave of the signal to receive, that is to say 12.5 cm at a frequency of 600 MHz. In this way, if one antenna receives a signal of minimum amplitude, that is to say in a trough of the signal also termed “signal node”, the second antenna receives a signal of maximum amplitude, that is to say in a signal antinode.

It should be noted that the bands IV and V used for the broadcasting of terrestrial television in France vary from 470 to 860 MHz (channels 21 to 69).

Similarly, the disposition of the antennae with respect to the portable digital terrestrial television apparatus and in particular in relation to the metal body of the apparatus is such that the antennae are placed as far as possible away from the metal body.

In this embodiment, the antennae 5 and 6 are fixed to the portable digital terrestrial television apparatus by connecting means 7 described later.

FIG. 1c illustrates the portable digital terrestrial television apparatus, viewed from the side and disposed in an inclined position enabling a user to comfortably view multimedia data, while having the apparatus placed on a horizontal support surface, such as a desk. Holding in inclined position for the user is achieved by means of a prop 8.

In this embodiment, the antennae 5 and 6 are strongly directional and are each formed by two elements of unequal height, as shown in FIG. 2. Other geometric shapes of antennae may also be envisaged.

The antennae 21 and 31, shown diagrammatically in FIG. 2, respectively correspond to the antennae 5 and 6 of FIG. 1a.

According to one embodiment, the long elements 21a and 31a are positioned close to the apparatus whereas the short elements 21b and 31b are placed away from the apparatus. Such an orientation of the antennae enables the zones of maximum sensitivity to have minimum overlap or even none at all, so giving maximum reduction in coupling.

Indeed, although an antenna is considered as a receiver, it partially re-transmits signals and may perturb another antenna close by: this is then referred to as coupling between the antennae.

Thus, the above implementation of the decoupling not only makes it possible to minimize or even prevent coupling, but also makes it possible not to receive the same signal from the same direction.

To do this, a disposition of the antennae is adopted such that the zones of maximum sensitivity of the antennae are separate.

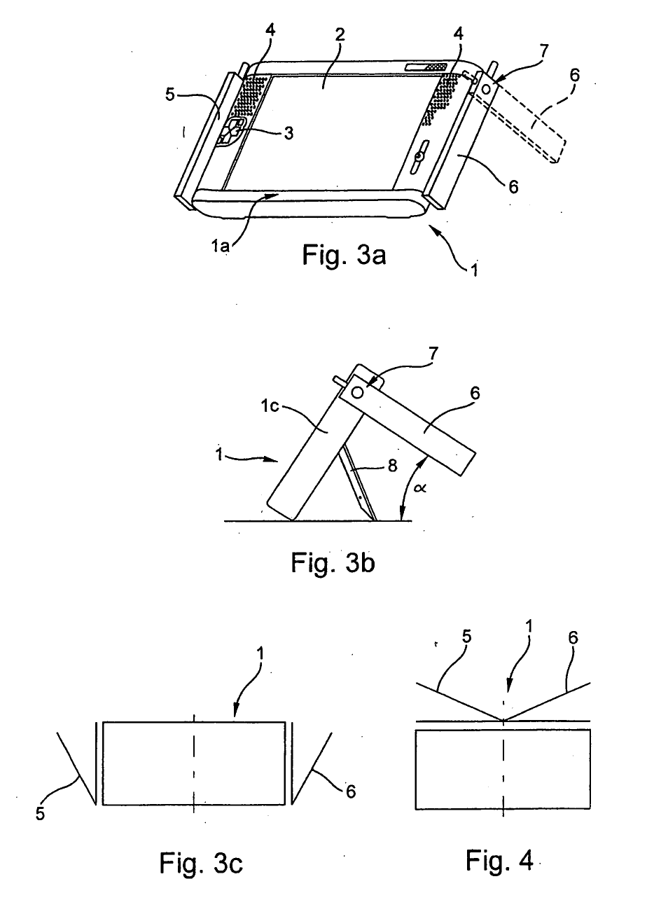

As illustrated in FIG. 3a, the antennae 5 and 6 are fixed to the portable digital terrestrial television apparatus 1, at one end of the lateral edges 1c of the apparatus, that is to say at the two corners of the apparatus, by connecting means 7.

In this embodiment, the antennae 5 and 6 are connected to two opposite corners of the apparatus in line with a longitudinal edge of the apparatus.

They may be deployed, for example by rotation about the fixing to the portable digital terrestrial television apparatus.

Such a hinged connection of the antennae of the portable digital terrestrial television apparatus makes it possible to deploy the antennae about a deployment axis corresponding here to a longitudinal edge 1b of the apparatus.

Furthermore, the deployment of the antennae with respect to the plane of the apparatus makes it possible to further reduce the perturbations created by the apparatus, and/or to improve the reception of the signal according to its polarity.

FIG. 3b illustrates the portable digital terrestrial television apparatus in a position enabling a user to view the screen of the device and which has the antennae deployed.

As illustrated in FIG. 3b, the angle α to the horizontal plane of the antennae 5 and 6 may vary from 0° to 360°. However, it is observed that an angle α of value 40° to 50°, or even of 30° to 70°, between the deployed antenna and the horizontal plane is optimum for a simultaneous reception of the two polarizations of the signal which are horizontal and vertical.

According to another variant of the deployment of the antennae on the portable digital terrestrial television apparatus, the antennae 5 and 6 are deployed in the plane of the apparatus as illustrated in FIG. 3c.

According to a variant of positioning the antennae on the portable digital terrestrial television apparatus, the antennae 5 and 6 are positioned on one of the longitudinal edges 1b as illustrated in FIG. 4.

These antennae 5 and 6 may pivot in the plane of the portable digital terrestrial television apparatus or perpendicularly to that plane.

This deployment of the antennae makes it possible to place them outside the zone of magnetic radiation of the portable digital terrestrial television apparatus, that is to say placed away from the mass plane of the portable digital terrestrial television apparatus, and to avoid the apparatus concealing the field of reception of the antennae.

The presence of these antennae close to the portable digital terrestrial television apparatus also necessitates adaptations of the portable digital terrestrial television apparatus, in particular for the processing of the signal in integrated circuits of the apparatus by the reception means to exploit the diversity in order to filter noise, treat echoes, correct errors and compensate for the Doppler effect.

The implementation made makes it possible to obtain better sensitivity for a given level of signal received, with an efficacious treatment of the Doppler effect which, in particular, enables use to be made in a moving vehicle.

This implementation also permits a greater capacity to process the different forms of noise induced by the electromagnetic interference due to the radiation emitted by the terminal which adds to the signal perturbations undergone at the time of its propagation, in particular the echoes produced by the multiple paths of the signal.

More particularly, the frequencies of DVB-T reception neighbor the harmonics of the frequencies of radiation of the active components of the terminal, which may create electromagnetic interference.

In a variant, the antennae 5 and 6 represented in FIGS. 1a to 4 are isotropic antennae, for example quarter wave antennae.

It should be noted here that isotropic antennae, in particular quarter wave antennae, have anisotropic behavior when they are close to each other. Such is the case on use of antennae on a portable digital terrestrial television apparatus.

It may consequently be understood that the above therefore also applies to isotropic antennae, such as quarter wave antennae.

As seen earlier, in a first variant embodiment for the connection of the antennae to the portable digital terrestrial television apparatus, the antennae 5 and 6 are fixed to the apparatus by means of a hinged connection 7. In this embodiment, the antennae are directly fixed to the edges of the terminal at the upper corners.

This hinged fixing enables the antennae to be deployed by rotation about the fixing point as illustrated in FIG. 3.

The angles of the two antennae in deployed position with respect to the horizontal support plane of the portable digital terrestrial television apparatus may be different. The variation in the deployment angles of the antennae enables the position giving the best reception quality to be sought.

The fixing of the antennae to the portable digital terrestrial television apparatus may also be demountable in order for the antennae to be detached, such that the antennae may be placed at a distance from each other and remote from the portable digital terrestrial television apparatus. In this way, the effectiveness of the diversity will be greater.

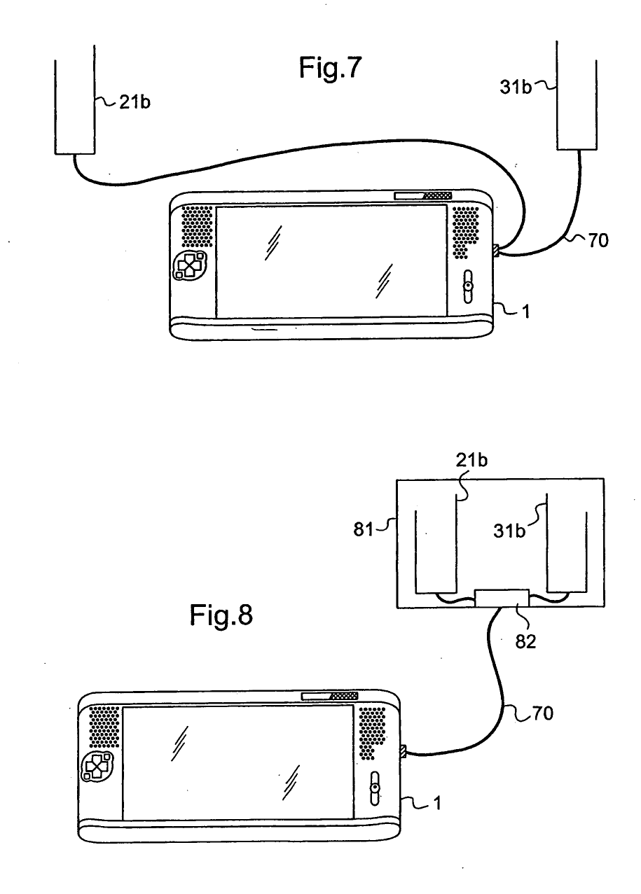

Different embodiments of such a configuration are described with reference to FIGS. 7 to 12 below.

Furthermore, in the case of use in a location equipped with a roof antenna, the incorporated antennae may be removed and the apparatus is then connected to the cable of the yagi antenna, so, in principle, providing a better signal-to-noise ratio and thus a better reception quality.

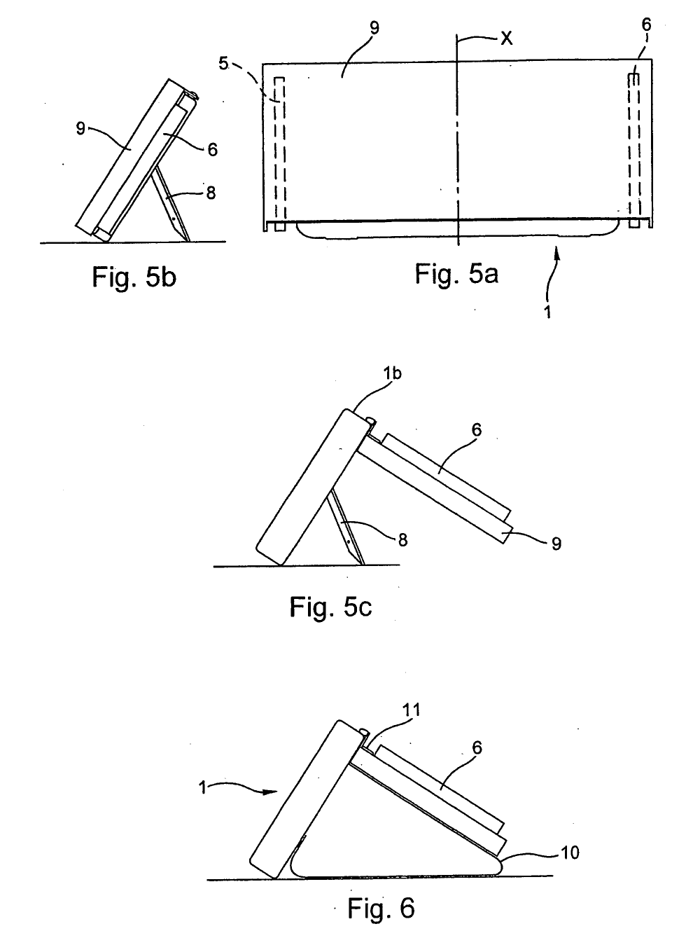

According to a variant embodiment for the connection of the antennae to the portable digital terrestrial television apparatus, illustrated in FIGS. 5a, 5b and 5c, the antennae 5 and 6 are incorporated in a support and in particular in a demountable flap 9 for protecting the screen.

The demountable flap is fixed to the portable digital terrestrial television apparatus by hinges, for example on a longitudinal edge 1b of the portable digital terrestrial television apparatus.

FIG. 5a illustrates the portable digital terrestrial television apparatus 1 provided with a flap 9 protecting the viewing screen in closed position. For this, the flap is placed above the viewing screen. The flap 9 comprises the antennae 5 and 6 positioned adjacent to the lateral edges of the device.

The antennae 5 and 6 are also disposed symmetrically with respect to an axis of symmetry X of the portable digital terrestrial television apparatus 1.

FIG. 5b illustrates this apparatus 1 in side view where the flap 9 obstructs the screen so as to protect it.

According to this variant, the deployment of the antennae is made by opening the flap as shown diagrammatically in FIG. 5c. Once it is open, the flap forms an angle of 260 to 280° with the front face of the portable digital terrestrial television apparatus. The flap may moreover serve as a prop, enabling use such that the portable digital terrestrial television apparatus is placed on a horizontal surface so as to render the viewing of the screen adapted to the user. Similarly, in this open position of the flap, the antennae 5 and 6 then form an optimum angle for reception of the signal, between 40 and 50°, with respect to the horizontal plane.

Finally, the demountable flap 9 may be removed in the following cases:

In a first case, the apparatus is used in fixed situation in which it may be advantageous to detach the flap and place it far from the terminal to improve the reception quality.

In a second case, it may be advantageous to detach the flap and to remove the antennae therefrom in order to place them far from each other and far from the portable digital terrestrial television apparatus.

Finally, when the user is in a location equipped with a reception antenna installed on the roof and providing a better signal-to-noise ratio, the flap is removed and the portable digital terrestrial television apparatus is connected to the cable of the yagi antenna using an adaptor cable which connects the co-axial plug to an antenna input of the portable digital terrestrial television apparatus.

According to another variant embodiment for the connection of the antennae to the portable digital terrestrial television apparatus, the antennae 5 and 6 are incorporated in the flap of a carrying case 10 of the portable digital terrestrial television apparatus 1, as illustrated in FIG. 6.

The case is fixed to the portable digital terrestrial television apparatus by means of a fastener 11.

According to this variant, the deployment of the antennae is made by opening the flap of the case as illustrated in FIG. 6.

Furthermore, that flap may be provided such that, once it has been turned over and attached to the back of the terminal, it serves as a prop enabling use in which the portable digital terrestrial television apparatus 1 is placed on a surface, with the front face equipped with the screen in an inclined position.

The portable digital terrestrial television apparatus may be taken out of the case in the following cases.

In a first case, the apparatus is used in fixed situation in which it may be advantageous to detach the case and the antennae incorporated therein and to place them far from the terminal to improve the reception quality.

In a second case, it may be advantageous to detach the case and to take out the antennae in order to place them far from each other and far from the portable digital terrestrial television apparatus.

Finally, when the user is in a location equipped with a reception antenna installed on the roof and providing a better signal-to-noise ratio, it is possible to remove the case with the antennae incorporated and to connect the portable digital terrestrial television apparatus to the cable coming down from the yagi antenna using an adaptor cable which connects the co-axial plug to an antenna input of the portable digital terrestrial television apparatus.

With reference to FIGS. 7 to 12 embodiments are now described in which the antennae are placed at a distance from the digital television apparatus.

When the antennae are away from the portable digital terrestrial television apparatus, these latter, borne by a support which is not shown, are connected to the apparatus by a wire connection 70 as illustrated in FIG. 7.

By placing away the antennae of the portable digital terrestrial television apparatus, as illustrated, the conditions for proper operation and reception are improved, whether the antennae have an anisotropic or an isotropic individual characteristic.

This is because this disposition promotes proper operation and reception by placing the antennae away from the source of noise produced by the portable digital terrestrial television apparatus.

This applies all the more if the antennae are placed away from each other, in particular by taking them out from their support, the benefit of diversity processing operations is maximized by the increase in the probability of capturing different signals from each of the antennae.

According to a preferred embodiment, the antennae are borne by the same support 81 adapted to be separated from the portable digital terrestrial television apparatus. Thus, according to need, it is possible to place the antennae away from the digital terrestrial television apparatus shown in FIG. 8.

The support 81 may also comprise means making it possible to incline the antennae with respect to a horizontal plane so as to obtain better signal reception.

Furthermore, the antennae support may comprise means 82 for amplifying the two signals captured by the antennae to ensure the transport thereof to the receiver contained in the digital terrestrial television apparatus 1.

This placing of the support containing the antennae may be at a distance of a few tens of centimeters to several meters.

The antennae support is composed, for example, of two parts connected together by a hinge means. Each of the parts comprises means for respectively holding each antenna.

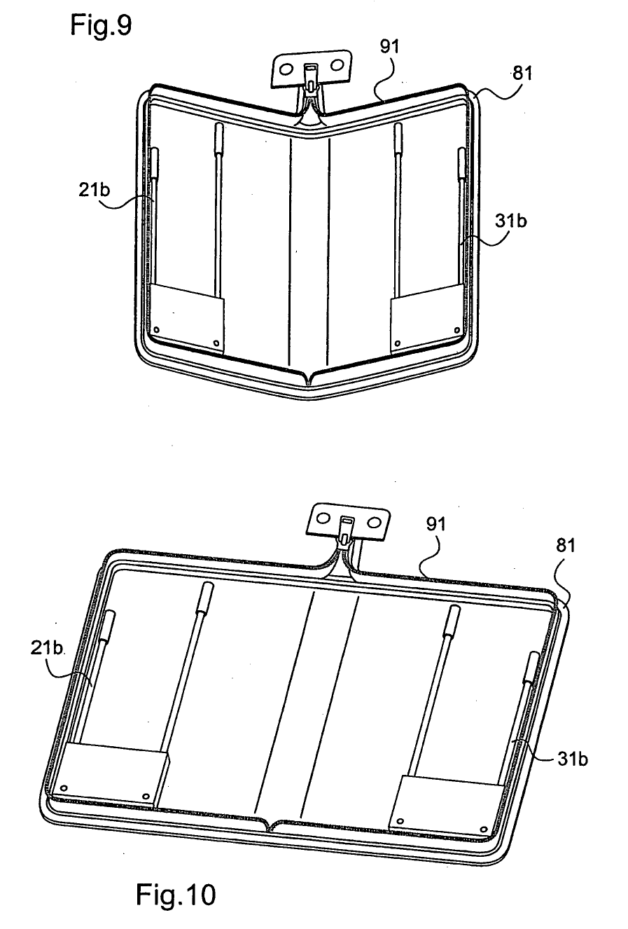

The antennae support may thus be put into partially open (FIG. 9) or fully open (FIG. 10) position with respect to the hinge axis, such that the antennae 21b, 31b are placed away from each other and thereby in a configuration favorable to good reception.

The antennae support 81 may, in the example considered, be constituted by an antennae case, that is to say take, in particular, the form of a book or a tool kit case. For this, it is formed by two rigid or semi-rigid parts connected together and pivotally mounted with respect to each other enabling the opening and closing of the case, so as to open on three sides. Furthermore, it comprises on its edges closure means 91, for example, a zip, in order to hold the case closed during transport of the antennae.

The antennae case may comprise pockets in which the antennae are inserted.

The case may also take the form of a sheath with a flap, the sheath comprising the first antenna and the flap the second antenna.

The antennae case, in a position that is open along the hinge axis, can be disposed flat on the table. In this way, the antennae are consequently also disposed flat. This configuration is particularly advantageous when the DTT transmitters use horizontal polarization.

Similarly, in a position open at an angle less than 180° along the hinge axis, the antennae case can be disposed vertically on the table. In this way, the antennae are consequently also disposed in a vertical plane. This configuration is particularly advantageous when the DTT transmitters use vertical polarization.

Means not shown may be provided to hold the case vertical, when it is open at 180°.

Furthermore, the antennae case, in the open position, may be held by means of a prop (not shown) such that the antennae form an angle with the plane of the table.

In a variant not shown the antennae support may also be in the form of a box having a hinged cover, the cover being provided with a sheath for an antenna and the bottom of the box having a second sheath for the second antenna.

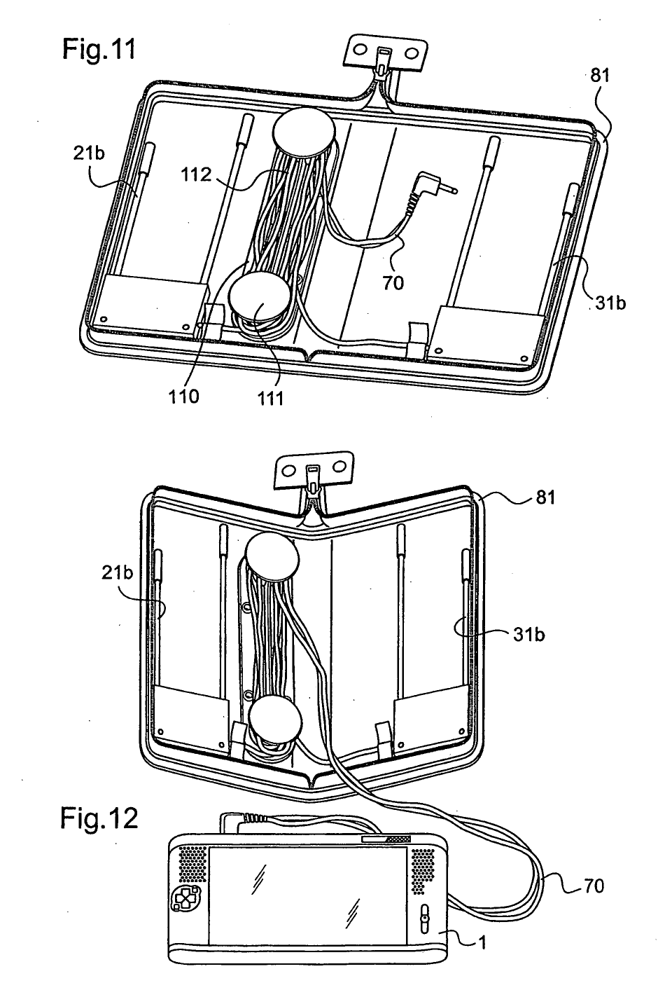

According to a specific embodiment represented in FIGS. 11 and 12, the antennae case may comprise means 110 adapted to store the wire 70 for connection to the portable digital terrestrial television apparatus during transport as illustrated in FIG. 11. This storage is here provided inside the case by means of a reel 111 for winding the cable. The base 112 of the reel may be connected to the case in particular by means of rivets and be positioned between the antennae.

FIG. 12 illustrates a portable digital terrestrial television apparatus connected by a wire connection 70 to the antennae 21b and 31b contained in the antennae case 81.

According to another embodiment not shown, two tuners 34 and 35 of FIGS. 1a to 1c respectively associated with the antennae may be positioned in the antennae case by detachable fixing means.

In particular, the tuners 34 and 35 may be inserted into the antennae case solely during the transport of the portable digital terrestrial television apparatus.

According to another specific embodiment, the two processing units providing the digital processing of correlation and of the diversity of the signals received by each of the antennae may be positioned in the antennae case by detachable fixing means.

As a variant, the two processing units, providing the digital processing of correlation and of the diversity of the signals, may be inserted into the antennae case solely during the transport of the portable digital terrestrial television apparatus.

It should be noted that, in still another variant, the antennae may be removed from the antennae case to be fixed by individual fixing means onto a substantially vertical wall, such as a partition wall or a window.

These fixing means may in particular be a sucker, or an adhesive. According to one embodiment, the sucker is connected to the antennae; as a variant, the sucker is positioned on the antenna prior to its use. This arrangement is particularly suitable for car use where the antennae may be deployed outside the antennae case in order to be fixed to the side window panes of the car using the suckers or adhesive.

It may easily be understood that the set of antennae in its support consists of a set which can be manipulated independently.

1. A portable digital terrestrial television device comprising a portable digital terrestrial television apparatus and means for receiving a digital signal of low power, wherein the reception means comprise two antennae for receiving the digital signal, the relative disposition of said antennae being adapted to reduce the coupling between said antennae, said antennae being borne by a support comprising means for connecting the antennae to the portable digital terrestrial television apparatus.

2. A portable digital terrestrial television device according to claim 1, wherein said antennae borne by the support are adapted to be placed away from the portable digital terrestrial television apparatus.

3. A portable digital terrestrial television device according to claim 2, wherein the antennae are connected to the portable digital terrestrial television apparatus by at least one wire connection.

4. A portable digital terrestrial television device according to claim 3, wherein the support comprises means for storing the wire connection.

5. A portable digital terrestrial television device according to claim 2, wherein the support comprises means for amplifying the signals captured by the antennae.

6. A portable digital terrestrial television device according to claim 2, wherein two detachable tuners are respectively associated with said antennae and the support comprises temporary fixing means for said detachable tuners.

7. A portable digital terrestrial television device according to claim 6, wherein the support comprises detachable fixing means for the means for processing the diversity of the digital signals adapted to process the digital signals received.

8. A portable digital terrestrial television device according to claim 2, wherein the antennae comprise fixing means adapted to be fixed to a substantially vertical wall.

9. A portable digital terrestrial television device according to claim 8, wherein the fixing means are suckers or adhesive.

10. A portable digital terrestrial television device according to claim 1, wherein the portable digital terrestrial television apparatus comprises a viewing screen and the support is a protecting flap for said viewing screen.

11. A portable digital terrestrial television device according to claim 10, wherein the protecting flap is fixed to the portable digital terrestrial television apparatus by hinges.

12. A portable digital terrestrial television device according to claim 11, wherein the protecting flap, in closed position, is above the viewing screen of said portable digital terrestrial television apparatus.

13. A portable digital terrestrial television device according to claim 11, wherein the protecting flap, in deployed position, is adapted to serve as a prop for said portable digital terrestrial television apparatus.

14. A portable digital terrestrial television device according to claim 11, wherein, when the protecting flap is in deployed position, the protecting flap forms an angle between 260° and 280° with said the viewing screen of the portable digital terrestrial television apparatus.

15. A portable digital terrestrial television device according to claim 11, wherein the protecting flap is adapted to be detached from said portable digital terrestrial television apparatus.

16. A portable digital terrestrial television device according to claim 1, wherein a carrying case is associated with said portable digital terrestrial television device, a flap of the carrying case forming said support and incorporating the antennae, and the flap being moveable between a closed position and a deployed position with respect to the portable digital terrestrial television apparatus.

17. A portable digital terrestrial television device according to claim 16, wherein, when the flap is in deployed position, the flap is adapted to serve as a prop for said portable digital terrestrial television apparatus.

18. A portable digital terrestrial television device according to claim 1, wherein the antennae support is constituted by an antennae case.

19. A portable digital terrestrial television device according to claim 18, wherein the antennae support comprises two parts hinged with respect to each other, each part comprising an antenna, the antennae support being adapted to be positioned partially or fully open with respect to the hinge axis to place the antennae away from each other.

20. A portable digital terrestrial television device according to claim 18, wherein the antennae case can be opened on three sides.

21. A portable digital terrestrial television device according to claim 1, wherein reception means comprise two tuners respectively associated with said antennae, and the portable digital terrestrial television device comprises means for processing the diversity of the digital signals adapted to process the digital signals output from said tuners.

22. A portable digital terrestrial television device according to claim 1, wherein the portable digital terrestrial television device comprises storage means and recording means adapted to record the digital signal in the storage means.

23. A portable digital terrestrial television device according to claim 1, wherein, in said disposition, the two antennae are disposed at a distance from each other greater than or equal to a quarter of the wavelength of the signal to be received.

24. A portable digital terrestrial television device according to claim 1, wherein said antennae have spatially anisotropic sensitivity

25. A portable digital terrestrial television device according to claim 24, wherein each antenna comprises two elements of unequal height.

26. A portable digital terrestrial television device according to claim 1, wherein said antennae are isotropic.

27. A portable digital terrestrial television device according to claim 26, wherein said antennae are quarter wave antennae.

28. A set of antennae adapted to be connected to a portable digital terrestrial television apparatus, those antennae being borne by a support such that those antennae may assume a disposition adapted to reduce the coupling between them, said support further comprising means for connecting to said portable digital terrestrial television apparatus.
